(19) United States
(12) Patent Application Publication
(10) Pub. No.: US 2026/0365112 A1
(43) Pub. Date: Nov. 19, 2026

(54) VEHICLE MONITORING DEVICE AND VEHICLE MONITORING METHOD

(71) Applicant: DENSO CORPORATION, Kariya-city (JP)

(72) Inventors: Shinichi MORIYAMA, Kariya-city (JP); Kouei KIYO, Kariya-city (JP)

(21) Appl. No.: 19/674,570

(22) Filed: May 12, 2026

(30) Foreign Application Priority Data
May 14, 2025 (JP) 2025-081479

(51) Int. Cl. B60R 1/29; B62D 33/023; G06T 11/60; H04N 7/18; H04N 23/90

(52) U.S. Cl. CPC B60R 1/29; B62D 33/023; G06T 11/60; H04N 7/18; H04N 23/90; B60R 2300/105; B60R 2300/303; B60R 2300/607; B60R 2300/8006

(57) ABSTRACT

In a vehicle monitoring device for use in a vehicle equipped with a bed that defines a space, an acquisition unit is configured to acquire a camera image captured by at least one of a front camera configured to capture an image forward of the vehicle and a rear camera configured to capture an image rearward of the vehicle. A display unit is configured to display a superimposed image in which an image captured by a bed camera configured to capture an image of the bed is superimposed on a bird's-eye view image. The bird's-eye view image is acquired from the camera image and showing the vehicle and surroundings of the vehicle as viewed from above the vehicle.

### CROSS-REFERENCE TO RELATED APPLICATION

This application is based on and claims the benefit of priority from earlier Japanese Patent Application No. 2025-081479 filed May 14, 2025, the description of which is incorporated herein by reference.

### BACKGROUND

### Technical Field

The present disclosure relates to a vehicle monitoring device and a vehicle monitoring method.

### Related Art

Conventionally, there has been known a vehicle monitoring device capable of acquiring images rearward of a vehicle and providing rearward monitoring assistance even when the vehicle is driven with a tailgate in an open state. A camera ECU of the vehicle monitoring device provides the rearward monitoring assistance using images captured by a rear camera when the tailgate is in a closed state. The camera ECU provides the rearward monitoring assistance using images captured by a bed camera when the tailgate is in an open state.

### BRIEF DESCRIPTION OF THE DRAWINGS

In the accompanying drawings:

FIG. 1 is a side view of a vehicle equipped with a vehicle monitoring device according to a first embodiment;

FIG. 2 is a view taken in the direction of the arrow II in FIG. 1;

FIG. 3A is a schematic block diagram of the vehicle;

FIG. 3B is a functional block diagram of the vehicle monitoring device;

FIG. 4 is a flowchart illustrating a routine performed by the vehicle monitoring device;

FIG. 5 is an illustration of a bird's-eye view image generated by the vehicle monitoring device;

FIG. 6 is an illustration of a superimposed image generated by the vehicle monitoring device;

FIG. 7 is an illustration of an underfloor area of the vehicle;

FIG. 8 is an illustration of an underfloor area of the vehicle;

FIG. 9 is an illustration of a composite image generated by the vehicle monitoring device;

FIG. 10 is a schematic block diagram of a vehicle equipped with a vehicle monitoring device according to a second embodiment;

FIG. 11 is a flowchart illustrating a routine performed by the vehicle monitoring device;

FIG. 12 is a flowchart illustrating a routine performed by a vehicle monitoring device according to a third embodiment; and

FIG. 13 is a side view of a vehicle equipped with a vehicle monitoring device according to another embodiment.

### DESCRIPTION OF SPECIFIC EMBODIMENTS

The bed camera of the known vehicle monitoring device, as disclosed in JP 2022-21082 A, captures an image rearward of the vehicle and also captures an image of a bed of the vehicle. The image captured by the bed camera may be transitioned to and displayed on a dedicated screen. However, when the image captured by the bed camera is transitioned to and displayed on the dedicated screen, the driver of the vehicle cannot simultaneously check the state of the vehicle and the state of the bed. Therefore, in the vehicle monitoring device disclosed in JP 2022-21082 A, it is difficult to monitor both the vehicle and its bed.

In view of the foregoing, it is desired to have a vehicle monitoring technique for facilitating monitoring of a vehicle and its truck or cargo bed.

A first aspect of the present disclosure provides a vehicle monitoring device for use in a vehicle equipped with a bed that defines a space. The vehicle monitoring device includes: an acquisition unit configured to acquire a camera image captured by at least one of a front camera configured to capture an image forward of the vehicle and a rear camera configured to capture an image rearward of the vehicle; and a display unit configured to display a superimposed image in which an image captured by a bed camera configured to capture an image of the bed is superimposed on a bird's-eye view image, the bird's-eye view image being acquired from the camera image and showing the vehicle and surroundings of the vehicle as viewed from above the vehicle.

A second aspect of the present disclosure provides a vehicle monitoring method for use in a vehicle equipped with a bed that defines a space. The vehicle monitoring method includes: acquiring a camera image captured by at least one of a front camera configured to capture an image forward of the vehicle and a rear camera configured to capture an image rearward of the vehicle; and displaying a superimposed image in which an image captured by a bed camera configured to capture an image of the bed is superimposed on a bird's-eye view image, the bird's-eye view image being acquired from the camera image and showing the vehicle and surroundings of the vehicle as viewed from above the vehicle.

A third aspect of the present disclosure provides a vehicle monitoring program product for use in a vehicle equipped with a bed that defines a space. The vehicle monitoring program product includes a non-transitory computer-readable medium storing instructions that, when executed by a computer included in a vehicle monitoring device, cause the computer to: acquire a camera image captured by at least one of a front camera configured to capture an image forward of the vehicle and a rear camera configured to capture an image rearward of the vehicle; and display a superimposed image in which an image captured by a bed camera configured to capture an image of the bed is superimposed on a bird's-eye view image, the bird's-eye view image being acquired from the camera image and showing the vehicle and surroundings of the vehicle as viewed from above the vehicle.

Accordingly, it is no longer necessary to display the image captured by the bed camera on a dedicated screen, and the driver of the vehicle can simultaneously view the state of the vehicle and the state of the bed. This facilitates monitoring of the vehicle and the bed.

Reference numerals in parentheses appended to the respective constituent elements and the like indicate one example of correspondence between the constituent elements and specific constituent elements described in embodiments set forth below.

Embodiments will now be described below with reference to the accompanying drawings. In the following embodiments, parts that are identical or equivalent to each other are denoted by the same reference numerals, and description thereof will be omitted.

### First Embodiment

A vehicle monitoring device that configured to perform a vehicle monitoring method according to a first embodiment facilitates monitoring of a vehicle and its bed. First, the vehicle equipped with the vehicle monitoring device will be described.

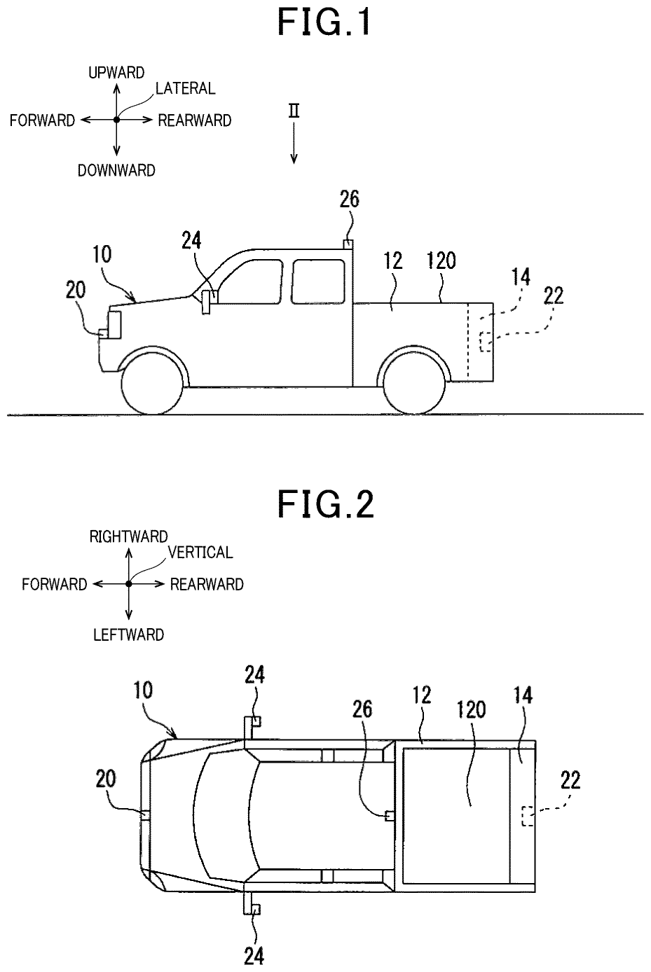

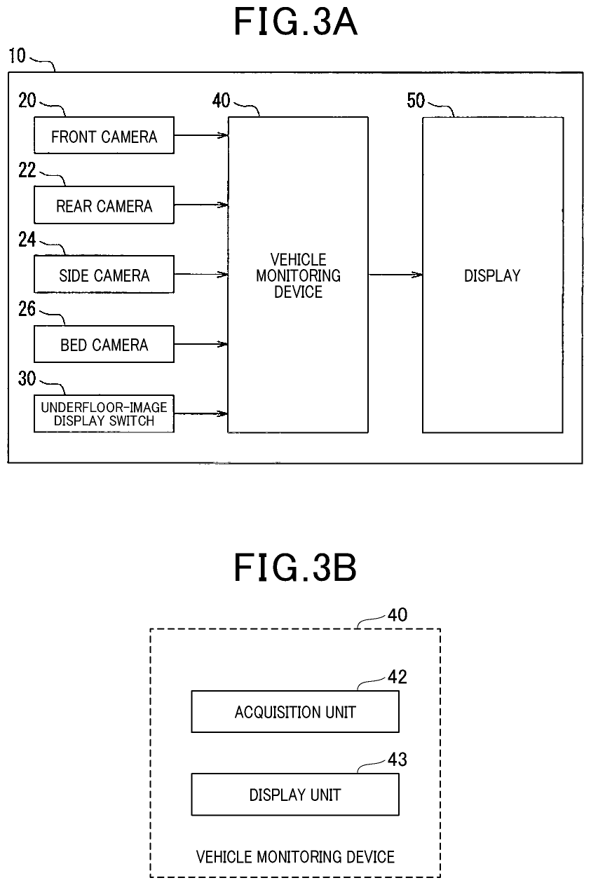

As illustrated in FIGS. 1 and 2, a vehicle 10 includes a bed 12 and a tailgate 14. As illustrated in FIGS. 1 to 3, the vehicle 10 includes a front camera 20, a rear camera 22, a side camera 24, and a bed camera 26. As illustrated in FIG. 3A, the vehicle 10 further includes an underfloor-image display switch 30, a vehicle monitoring device 40, and a display 50.

Referring again to FIGS. 1 and 2, the bed 12 is provided at a rear side of the vehicle 10. The bed 12 defines an open space 120. The open space 120 is open upward of the vehicle 10.

The tailgate 14 is attached to a rear end of the bed 12 of the vehicle 10. The tailgate 14 opens and closes a rear opening of the open space 120. Accordingly, when the tailgate 14 is opened, the rear opening of the open space 120 is exposed. When the tailgate 14 is closed, the open space 120 is enclosed by the bed 12 and the tailgate 14.

As illustrated in FIGS. 1 to 3, the front camera 20 may be attached, for example, to a front end of the vehicle 10. The front camera 20 captures an image of an area ahead of the vehicle 10. The front camera 20 transmits the captured image to the vehicle monitoring device 40 described later.

The rear camera 22 may be attached, for example, to a rear end of the tailgate 14 of the vehicle 10. The rear camera 22 captures an image of an area behind the vehicle 10. The rear camera 22 transmits the captured image to the vehicle monitoring device 40 described later.

The side cameras 24 may be attached, for example, to left and right side mirrors of the vehicle 10. The side cameras 24 capture images of areas to the left and right of the vehicle 10. The side cameras 24 transmit the captured images to the vehicle monitoring device 40 described later.

The bed camera 26 may be attached, for example, to an upper central portion of the vehicle 10. The bed camera 26 captures an image of the bed 12. The bed camera 26 transmits the captured image to the vehicle monitoring device 40 described later.

The underfloor-image display switch 30 is turned on and off by a driver of the vehicle 10. When the underfloor-image display switch 30 is turned on, the underfloor-image display switch 30 transmits, to the vehicle monitoring device 40 described later, a signal to display a composite image Img_C described later. When the underfloor-image display switch 30 is turned off, the underfloor-image display switch 30 transmits, to the vehicle monitoring device 40 described later, a signal not to display the composite image Img_C described later.

The vehicle monitoring device 40 is mainly configured by a microcomputer or the like, and includes a CPU, a ROM, a flash memory, a RAM, an I/O interface, a communication interface, and a bus line connecting these components. The vehicle monitoring device 40 executes a program stored in the ROM of the vehicle monitoring device 40.

The vehicle monitoring device 40 acquires images captured by the front camera 20, the rear camera 22, the side cameras 24, and the bed camera 26. The vehicle monitoring device 40 further acquires the signals from the underfloor-image display switch 30. The vehicle monitoring device 40 generates a superimposed image Img_O and a composite image Img_C, both described later, by using the acquired captured images and the signals from the underfloor-image display switch 30. The vehicle monitoring device 40 transmits, to the display 50, signals to display the generated images. The images generated by the vehicle monitoring device 40 are thus displayed on the display 50. A routine performed by the vehicle monitoring device 40 will be described later.

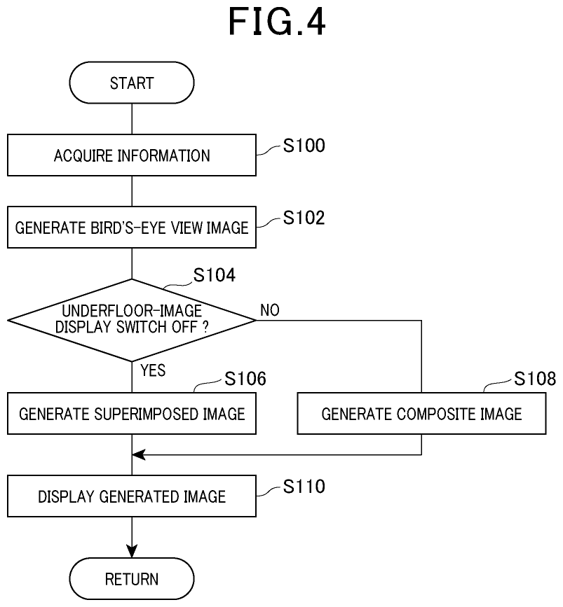

The vehicle 10 equipped with the vehicle monitoring device 40 according to the present embodiment is configured as described above. Next, the routine performed by the vehicle monitoring device 40 through execution of the program will be described with reference to the flowchart of FIG. 4. The program for the vehicle monitoring device 40 may be executed, for example, in response to the vehicle 10 being powered on.

At step S100, the vehicle monitoring device 40 acquires various items of information. Specifically, the vehicle monitoring device 40 acquires images captured by the front camera 20, the rear camera 22, the side cameras 24, and the bed camera 26. The vehicle monitoring device 40 further acquires a signal from the underfloor-image display switch 30.

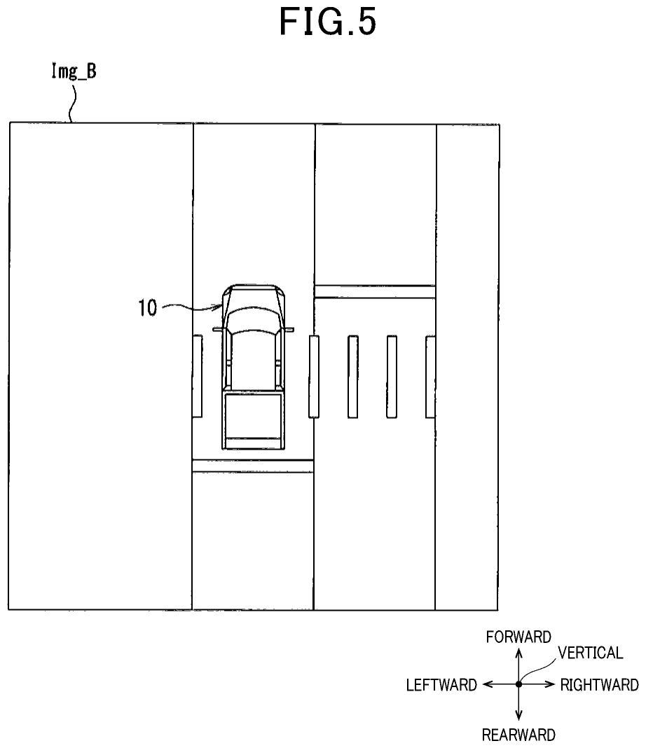

At step S102 following step S100, the vehicle monitoring device 40 performs image processing using the images captured by the front camera 20, the rear camera 22, and the side cameras 24 that are acquired at step S100. As illustrated in FIG. 5, the vehicle monitoring device 40 thus generates a bird's-eye view image Img_B. The bird's-eye view image Img_B is an image of the vehicle 10 and surroundings of the vehicle 10 as viewed from above the vehicle 10.

Referring back to the flowchart of FIG. 4, at step S104 following step S102, the vehicle monitoring device 40 determines, based on the signal from the underfloor-image display switch 30 acquired at step S100, whether the underfloor-image display switch 30 is on or off. Based on this determination, the vehicle monitoring device 40 determines whether to generate the superimposed image Img_O or the composite image Img_C described later.

When the underfloor-image display switch 30 is on, the vehicle monitoring device 40 determines that the composite image Img_C is to be generated. Thereafter, the routine performed the vehicle monitoring device 40 proceeds to step S108. When the underfloor-image display switch 30 is off, the vehicle monitoring device 40 determines that the superimposed image Img_O is to be generated. Thereafter, the routine performed by the vehicle monitoring device 40 proceeds to step S106.

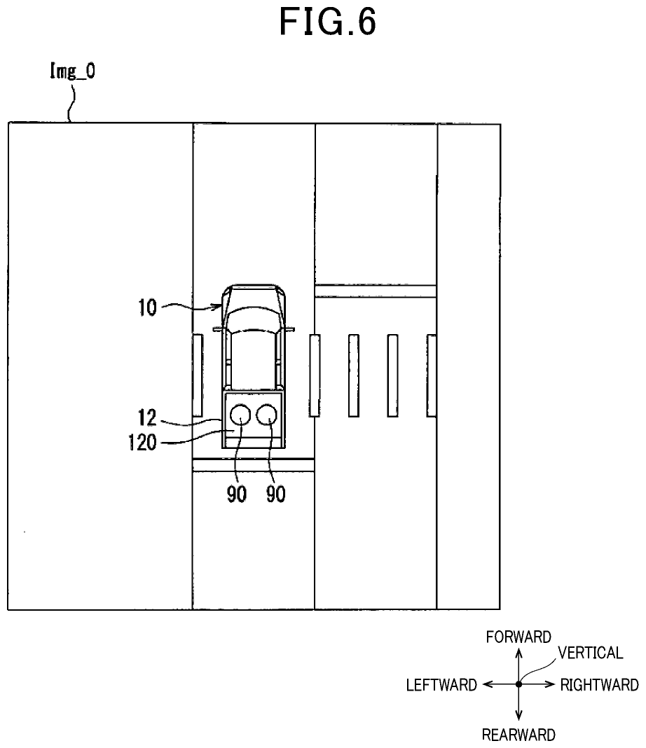

At step S106 following step S104, the vehicle monitoring device 40 uses image processing to convert the image captured by the bed camera 26 acquired at step S100 into an image as viewed from above the vehicle 10. The vehicle monitoring device 40 further superimposes the converted captured image from the bed camera 26 on the bird's-eye view image Img_B generated at step S102. Thus, as illustrated in FIG. 6, the vehicle monitoring device 40 generates the superimposed image Img_O. Thereafter, the routine performed the vehicle monitoring device 40 proceeds to step S110. For illustrative purposes, in the superimposed image Img_O of FIG. 6, an image showing objects 90 located in the open space 120 of the bed 12 is superimposed on the bird's-eye view image Img_B.

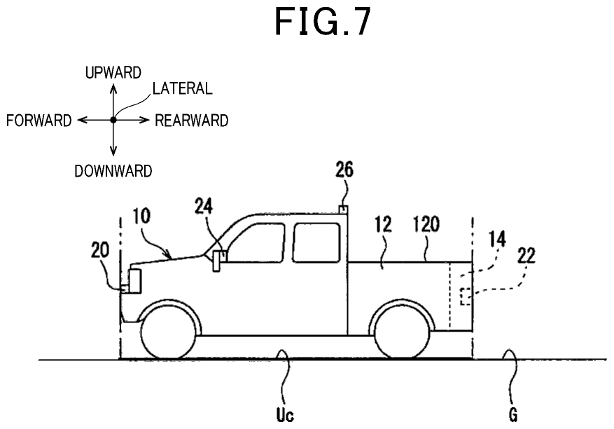

Here, as illustrated in FIG. 7, a portion of the road surface G on which the vehicle 10 is traveling and that overlaps the vehicle 10 when the vehicle 10 is projected downward is referred to as an underfloor area Uc.

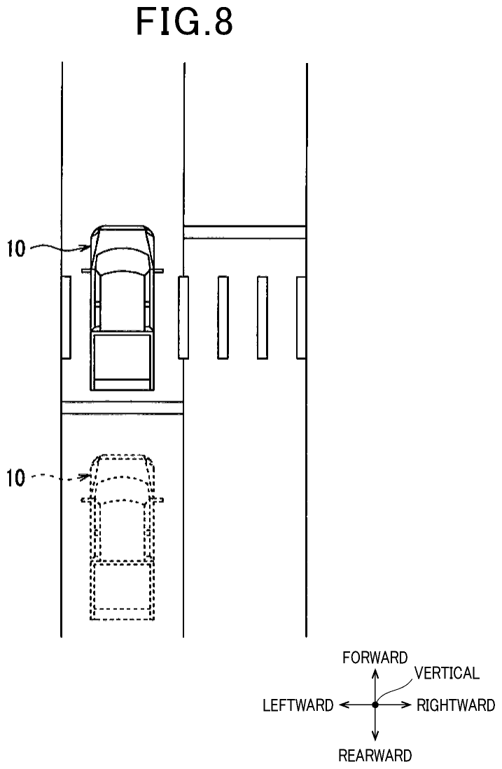

As illustrated in FIG. 8, the current underfloor area Uc appears, while the vehicle 10 is traveling, in an image captured in the past by the front camera 20 or the rear camera 22. In FIG. 8, the current vehicle 10 is indicated by solid lines. A past position of the vehicle 10 is indicated by broken lines.

Accordingly, at step S108 following step S104 in the flowchart of FIG. 4, the vehicle monitoring device 40 extracts, from images captured by the front camera 20 and the rear camera 22 and previously acquired and stored at step S110, an image showing the current underfloor area Uc. The vehicle monitoring device 40 then uses image processing to convert the extracted image showing the underfloor area Uc into an image as viewed from above the vehicle 10. The vehicle monitoring device 40 further combines the converted image of the underfloor area Uc with an image of an outline of the vehicle 10 and the tires 100 as viewed from above the vehicle 10, and composites the combined image onto the bird's-eye view image Img_B generated at step S102.

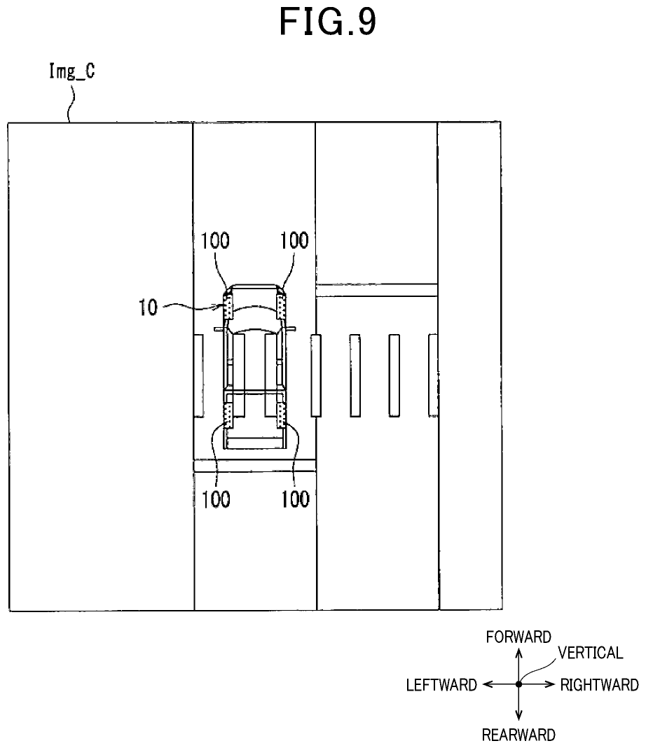

Thus, as illustrated in FIG. 9, the vehicle monitoring device 40 generates the composite image Img_C. Thereafter, the routine performed the vehicle monitoring device 40 proceeds to step S110. The outline of the vehicle 10 in the composite image Img_C is predefined for each vehicle type. The positions of the tires 100 in the composite image Img_C are predefined for each vehicle type. The orientations of the tires 100 in the composite image Img_C are set according to steering of the vehicle 10. In the composite image Img_C of FIG. 9, portions of the vehicle 10 other than the tires 100 are transparent. For illustrative purposes, in the composite image Img_C of FIG. 9, a crosswalk in the underfloor area Uc is composited onto the bird's-eye view image Img_B. Further, in FIG. 9, the tires 100 are shown with a dot pattern in order to clearly indicate the tires 100.

Referring back to the flowchart of FIG. 4, at step S110, the vehicle monitoring device 40 transmits, to the display 50, a signal to display whichever of the superimposed image Img_O generated at step S106 and the composite image Img_C generated at step S108 has been generated. Accordingly, the image generated by the vehicle monitoring device 40 is displayed on the display 50. Thereafter, the routine performed the vehicle monitoring device 40 returns to step S100.

As described above, the vehicle monitoring device 40 performs the routine. Next, how the vehicle monitoring device 40 facilitates monitoring of the vehicle 10 and the bed 12 will be described.

Referring to FIG. 3B, the vehicle monitoring device 40 includes, as functional blocks, an acquisition unit 42 configured to acquire, at step S100, images captured by the front camera 20, the rear camera 22, the side cameras 24, and the bed camera 26, and a display unit 44 configured to display, at steps S106 and S110, the superimposed image Img_O. The acquisition unit 42 and the display unit 44 may be implemented by executing the program stored in the ROM of the vehicle monitoring device 40. The images captured by the front camera 20, the rear camera 22, and the side cameras 24 correspond to camera images.

With this configuration, it is no longer necessary to display the image captured by the bed camera 26 on a dedicated screen, and the driver of the vehicle 10 can simultaneously view a state of the vehicle 10 and a state of the bed 12. This facilitates monitoring of the vehicle 10 and the bed 12.

Further, the vehicle monitoring device 40 according to the first embodiment provides the advantages described below.

[1] If an image of the underfloor area Uc is composited onto the superimposed image Img_O, the image of the underfloor area Uc overlaps the bed 12. Thus, it is difficult to simultaneously display the state of the bed 12 and the underfloor area Uc.

In contrast, when the underfloor-image display switch 30 is off, the vehicle monitoring device 40 causes the superimposed image Img_O to be displayed. At steps S108 and S110, when the underfloor-image display switch 30 is on, the vehicle monitoring device 40 causes the composite image Img_C to be displayed instead of the superimposed image Img_O. As described above, the composite image Img_C is an image obtained from images captured by the front camera 20 and the rear camera 22, and is formed by compositing an image of the underfloor area Uc with an image of the outline of the vehicle 10 and the tires 100 as viewed from above the vehicle 10.

This allows the driver of the vehicle 10 to see the underfloor area Uc. As a result, collisions between a lower portion of the vehicle 10 and obstacles on the underfloor area Uc can be more easily avoided. Further, this allows the driver of the vehicle 10 to more easily recognize the inner-wheel difference of the vehicle 10. As a result, collisions caused by the inner-wheel difference of the vehicle 10 can also be more easily avoided.

### Second Embodiment

In a second embodiment, the configuration of the vehicle 10 differs from that in the first embodiment. The routine performed by the vehicle monitoring device 40 also differs from that in the first embodiment. In all other respects, the second embodiment is the same as the first embodiment.

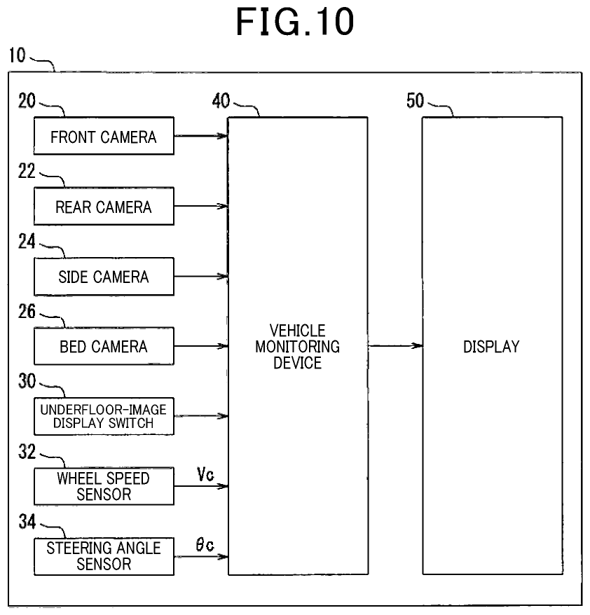

As illustrated in FIG. 10, the vehicle 10 further includes a wheel speed sensor 32 and a steering angle sensor 34.

The wheel speed sensor 32 detects a rotational speed of a wheel of the vehicle 10. Based on the detected rotational speed, the wheel speed sensor 32 detects a vehicle speed Vc. The wheel speed sensor 32 further transmits, to the vehicle monitoring device 40, a signal corresponding to the detected vehicle speed Vc. The vehicle speed Vc represents the speed of the vehicle 10.

The steering angle sensor 34 may be attached, for example, to a steering rod of the vehicle 10. The steering angle sensor 34 transmits, to the vehicle monitoring device 40, a signal corresponding to a steering angle θc of a steering wheel caused by an operation of a driver of the vehicle 10.

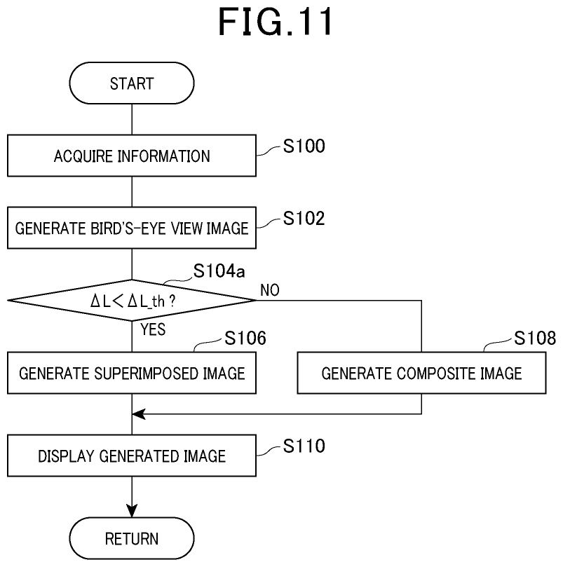

Next, the routine performed by the vehicle monitoring device 40 will be described. As illustrated in the flowchart of FIG. 11, at step S100, the vehicle monitoring device 40 acquires various items of information. Specifically, the vehicle monitoring device 40 acquires images captured by the front camera 20, the rear camera 22, the side cameras 24, and the bed camera 26. Further, instead of acquiring a signal from the underfloor-image display switch 30, the vehicle monitoring device 40 acquires the vehicle speed Vc from the wheel speed sensor 32. The vehicle monitoring device 40 also acquires the steering angle θc from the steering angle sensor 34. The process at step S102 following step S100 is performed in the same manner as in the first embodiment.

Here, a distance traveled by the vehicle 10 since the vehicle 10 started traveling is defined as a travel amount ΔL. When the travel amount ΔL is small, only a small number of images captured by the front camera 20 and the rear camera 22 have been acquired and stored at step S100. Accordingly, when the travel amount ΔL is small, only a small number of images showing the current underfloor area Uc are available, making it difficult to composite an image showing the current underfloor area Uc onto the bird's-eye view image Img_B. Therefore, when the travel amount ΔL is small, it is difficult to generate the composite image Img_C.

Accordingly, at step S104a following step S102, the vehicle monitoring device 40 calculates the current travel amount ΔL based on the vehicle speed Vc and the steering angle θc acquired at step S100, the processing cycle τ, and the travel amount ΔL traveled since the vehicle 10 started traveling. The vehicle monitoring device 40 further determines whether the calculated travel amount ΔL is less than a threshold ΔL_th. Based on this determination, the vehicle monitoring device 40 determines whether to generate the superimposed image Img_O or the composite image Img_C. The processing cycle τ is a period of a series of operations from when the routine is initiated at step S100 to when the routine returns to step S100. The threshold ΔL_th may be set, for example, through experiments or simulations so that the vehicle monitoring device 40 can determine whether to generate the superimposed image Img_O or the composite image Img_C.

When the travel amount ΔL is greater than or equal to the threshold ΔL_th, a sufficient number of images captured by the front camera 20 and the rear camera 22 have been stored since the vehicle 10 started traveling, and therefore, the composite image Img_C can be readily generated. Accordingly, the vehicle monitoring device 40 determines that the composite image Img_C is to be generated, and the routine performed the vehicle monitoring device 40 proceeds to step S108. When the travel amount ΔL is less than the threshold ΔL_th, only a small number of images captured by the front camera 20 and the rear camera 22 have been stored since the vehicle 10 started traveling, and therefore it is difficult to generate the composite image Img_C. Accordingly, the vehicle monitoring device 40 determines that the superimposed image Img_O is to be generated, and the routine performed the vehicle monitoring device 40 proceeds to step S106. The processes at step S106, step S108, and step S110 are performed in the same manner as in the first embodiment.

In the second embodiment, the vehicle monitoring device 40 performs the routine described above in the vehicle 10. The second embodiment also provides advantages similar to those of the first embodiment.

### Third Embodiment

In the third embodiment, the process at step S104 performed by the vehicle monitoring device 40 differs from that in the first embodiment. In all other respects, the third embodiment is the same as the first embodiment.

Here, when no object 90 is present in the bed 12, there is little need to generate the superimposed image Img_O because there is no object in the bed 12 to be monitored.

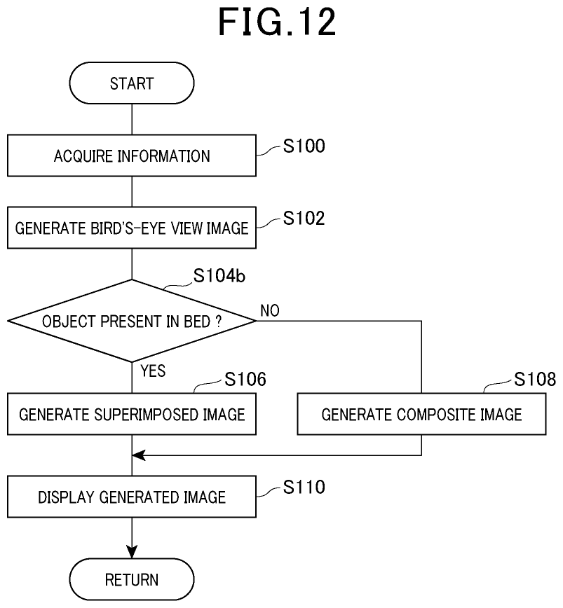

As illustrated in the flowchart of FIG. 12, at step S104b following step S102, the vehicle monitoring device 40 determines whether an object 90 is present in the bed 12 based on the image captured by the bed camera 26 acquired at step S100, using image processing and machine learning. Based on this determination, the vehicle monitoring device 40 determines whether to generate the superimposed image Img_O or the composite image Img_C.

When no object 90 is present in the bed 12, the vehicle monitoring device 40 determines that the composite image Img_C is to be generated, because there is no object in the bed 12 to be monitored and therefore little need to generate the superimposed image Img_O. Thereafter, the routine performed the vehicle monitoring device 40 proceeds to step S108. When an object 90 is present in the bed 12, the vehicle monitoring device 40 determines that the superimposed image Img_O is to be generated, because there is an object in the bed 12 to be monitored and therefore a greater need to generate the superimposed image Img_O. Thereafter, the routine performed the vehicle monitoring device 40 proceeds to step S106. The processes at step S106, step S108, and step S110 are performed in the same manner as in the first embodiment.

In the third embodiment, the vehicle monitoring device 40 performs the routine described above in the vehicle 10. The third embodiment also provides advantages similar to those of the first embodiment.

### Other Embodiments

The present disclosure is not limited to the above-described embodiments, and various modifications may be made to the above-described embodiments as appropriate. Further, in each of the above-described embodiments, it goes without saying that elements constituting the embodiments are not necessarily essential, except for cases where such elements are explicitly stated to be essential or are considered to be clearly essential in principle.

The display unit and the method thereof described in the present disclosure may be realized by a dedicated computer provided by configuring a processor and memory programmed to perform one or more functions embodied in a computer program. Alternatively, the display unit and the method thereof described in the present disclosure may be realized by a dedicated computer provided by configuring a processor with one or more dedicated hardware logic circuits. Alternatively, the display unit and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

In each of the above embodiments, the vehicle 10 includes the front camera 20, the rear camera 22, the side cameras 24, and the bed camera 26. Alternatively, the vehicle 10 may omit the side cameras 24. In this case, the bird's-eye view image Img_B is generated from images captured by the front camera 20 and the rear camera 22.

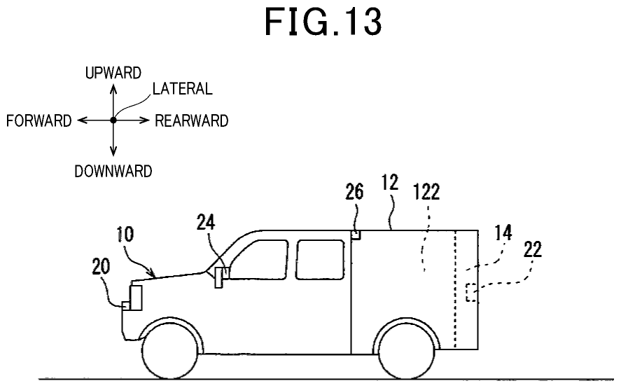

In each of the above embodiments, the bed 12 and the tailgate 14 define the open space 120. However, the bed 12 is not limited to defining the open space 120 together with the tailgate 14. As illustrated in FIG. 13, the bed 12 including a roof, and the tailgate 14 may instead define a closed space 122. In this case, instead of being attached to an upper central portion of the vehicle 10, the bed camera 26 may be attached, for example, at a position in the bed 12 from which the closed space 122 is visible.

What is claimed is:

1. A vehicle monitoring device for use in a vehicle equipped with a bed that defines a space, the vehicle monitoring device comprising:
an acquisition unit configured to acquire a camera image captured by at least one of a front camera configured to capture an image forward of the vehicle and a rear camera configured to capture an image rearward of the vehicle; and
a display unit configured to display a superimposed image in which an image captured by a bed camera configured to capture an image of the bed is superimposed on a bird's-eye view image, the bird's-eye view image being acquired from the camera image and showing the vehicle and surroundings of the vehicle as viewed from above the vehicle.

2. The vehicle monitoring device according to claim 1, wherein
the display unit is configured to display a composite image in which an image of a portion of a road surface on which the vehicle is traveling and an image of an outline of the vehicle and tires as viewed from above the vehicle are superimposed on the bird's-eye view image, the portion overlapping the vehicle when the vehicle is projected downward.

3. The vehicle monitoring device according to claim 2, wherein
the vehicle includes a switch, and
the display unit is configured to display the superimposed image when the switch is off, and display the composite image when the switch is on.

4. The vehicle monitoring device according to claim 2, wherein
the display unit is configured to display the superimposed image when a travel amount of the vehicle is less than a threshold, and to display the composite image when the travel amount is greater than or equal to the threshold.

5. The vehicle monitoring device according to claim 2, wherein
the display unit is configured to display the superimposed image when an object is present in the bed, and to display the composite image when no object is present in the bed.

6. The vehicle monitoring device according to claim 1, wherein
the bed is provided at a rear side of the vehicle,
the vehicle further includes a tailgate attached to a rear end of the bed, and
the bed and the tailgate together define an open space that is open upward of the vehicle when the tailgate is closed.

7. The vehicle monitoring device according to claim 6, wherein
the rear camera is attached to a rear end of the tailgate of the vehicle, and
the bed camera is attached to an upper central portion of the vehicle.

8. The vehicle monitoring device according to claim 1, wherein
the bed includes a roof and is provided at a rear side of the vehicle,
the vehicle further includes a tailgate attached to a rear end of the bed, and
the bed and the tailgate together define a closed space.

9. The vehicle monitoring device according to claim 8, wherein
the rear camera is attached to a rear end of the tailgate of the vehicle, and
the bed camera is attached at a position in the bed from which position the closed space is visible.

10. The vehicle monitoring device according to claim 4, wherein
the travel amount of the vehicle is a distance traveled by the vehicle since the vehicle started traveling.

11. A vehicle monitoring method for use in a vehicle equipped with a bed that defines a space, the vehicle monitoring method comprising:
acquiring a camera image captured by at least one of a front camera configured to capture an image forward of the vehicle and a rear camera configured to capture an image rearward of the vehicle; and
displaying a superimposed image in which an image captured by a bed camera configured to capture an image of the bed is superimposed on a bird's-eye view image, the bird's-eye view image being acquired from the camera image and showing the vehicle and surroundings of the vehicle as viewed from above the vehicle.

12. A vehicle monitoring program product for use in a vehicle equipped with a bed that defines a space, the vehicle monitoring program product comprising:
a non-transitory computer-readable medium storing instructions that, when executed by a computer included in a vehicle monitoring device, cause the computer to:
acquire a camera image captured by at least one of a front camera configured to capture an image forward of the vehicle and a rear camera configured to capture an image rearward of the vehicle; and
display a superimposed image in which an image captured by a bed camera configured to capture an image of the bed is superimposed on a bird's-eye view image, the bird's-eye view image being acquired from the camera image and showing the vehicle and surroundings of the vehicle as viewed from above the vehicle.
